(19) United States
(12) Patent Application Publication
(10) Pub. No.: US 2004/0128307 A1
(43) Pub. Date: Jul. 1, 2004

(54) Method of storing and retrieving database records that stores multiple field values within directory entries of an underlying operating system

(75) Inventor: Dominic John Repici, Riverside, NJ (US)

Correspondence Address: DOMINIC JOHN REPICI, 120 JEFFERSON ST., RIVERSIDE, NJ, 08075, US

(73) Assignee: Creativyst, Inc., Riverside, NJ

(21) Appl. No.: 10/334,243

(22) Filed: Dec. 30, 2002

(51) Int. Cl. G06F 17/00

(52) U.S. Cl. 707/102

(57) ABSTRACT

The method disclosed stores and retrieves records of a database by storing some or all field values from records within directory entries of an underlying operating system, wherein more than one field value is stored in each single directory entry used in the underlying operating system for the invention.

The described embodiment defines a set of escape sequences to escape characters within fields such as characters that are not acceptable for use in directory entries in the underlying operating system, and characters reserved for use by the method.

Directory entries are constructed by concatenating escaped fields into a single string, possibly utilizing field delimiters when it is necessary to denote their size. Resulting directory entries are stored and retrieved within the underlying operating system. Fields are recovered by splitting retrieved directory entries into constituent fields that have been un-escaped.

Method of storing and retrieving database records that stores multiple field values within directory entries of an underlying operating system.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates to data storage organized within database tables. Software applications that require information storage often store database information within simple files in an operating system in such a way that information associated with each single record are kept one to a line on each line within a file. The file itself in these cases is named with a table name or designator used to refer to the table. If the database consists of a single table then it may also be the designator for the entire database.

It is also a widely used practice for each file to be configured to contain the field values of a single record within the contents of the file, and having for a name, a single field value from the record. This one field value is used as the file name in the underlying operating system and, because it contains the value of one of the fields, also can be thought of as the unchangeable key field into the record. An example of this would be a member record for members in an online community in which the file containing the record for a particular member is named with the handle used by the member to log in. Other information stored within the record, such as the member's email address, password, last access date and time, and preferences are then stored within the file so named.

This practice of using a directory label to hold a single key value has been quite common and used in a conventional fashion for some time, though, to my knowledge, and after considerable searching, only as a means of providing a single identifier for a file which holds the contents of the remaining fields of the record.

The invention described in this disclosure claims a method of storing records, which stores more than one of some or all of the actual field values from database records within directory entry names of an underlying operating system, and allowing for the retrieval of those values in their original form from the directory entry.

There are many benefits of storing field values of records within directory entry names as described by this invention. Record access performance is improved in a variety of ways. For example, when only those fields stored within directory entries are required by the application, no extra file read operation is necessary. Also, many underlying operating systems will have had considerable attention paid to the speed at which directory entries are read and accessed, and will employ special dedicated mechanisms such as directory caches which provide great increases in the speed at which these entries can be scanned, listed, and searched.

Other benefits include storage of records in a stable indexing system that is native to the underlying operating system itself, and storage of records in a format that is more generic than traditional database storage techniques, requiring only the directory listing facilities of the underlying operating system to browse.

### BRIEF SUMMARY OF THE INVENTION

The invention claimed is a method of storing and retrieving records of a database by storing some or all field values from database records within directory entries of an underlying operating system, such that more than one field value is stored in each single directory entry used for the invention. Fields stored in this fashion are retrieved by reading directory entries in the underlying operating system that have been used to store field values and extracting each of the multiple field values from them to be returned as a portion or all of the database records stored.

The embodiment described achieves this by escaping the characters within each field value when necessary into escape sequences comprised of sequences of character values that are acceptable for use within directory entry names by the underlying operating system, and which can be unambiguously un-escaped (converted back) into their original values when records are read.

### BRIEF DESCRIPTION OF THE SEVERAL VIEWS OF THE DRAWING

FIG. 1: Is a flow chart view showing the process used in the embodiment for storing records to the underlying operating system and for storing some or all of the record's field values within a directory entry.

FIG. 2: Is a flow chart view showing the process used in the embodiment for retrieving records from the underlying operating system and for retrieving those field values stored within a directory entry.

FIG. 3: Is a flow chart view showing an example of a process used in the embodiment for storing records to the underlying operating system wherein fields of said are of fixed width and do not require field separators.

FIG. 4: Is a flow chart view showing the process used in the embodiment for retrieving records from the underlying operating system and for retrieving those field values stored within a directory entry, wherein fields of said records are of fixed width and do not require field separators.

### DETAILED DESCRIPTION OF THE INVENTION

In this embodiment, escape sequences are defined and used for a set of characters consisting of at least all those characters that are unacceptable within directory entry names within the underlying operating system.

Escape sequences are also defined for some valid character values that are acceptable for use in names in the underlying operating system, but which are used by the embodiment to represent field separators, and to introduce the escape sequences themselves.

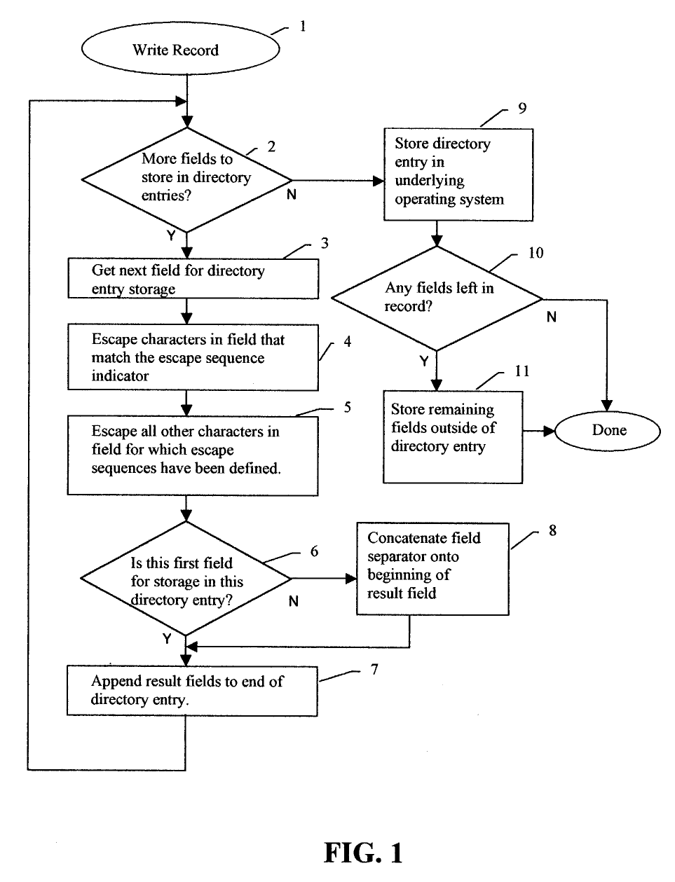

FIG. 1 on the first sheet of the drawings is a view of a flow chart of a process of saving record that includes an embodiment of the invention wherein field separators are used within directory entries. When writing a record 1, for each field 3 that is to be stored within directory entries 2, the embodiment will escape characters in fields that match values or which escape sequences have been defined 4, 5. As is customary, escape sequence introducer characters found within field values are transformed first 4, before other transformations 5, because escape sequence introducer characters left within field values by subsequent escaping operations belong there and must not be subsequently escaped.

The following software function, written in the perl programming language demonstrates an example of an escaping function for use in steps 4 and 5 which takes a field value as input and returns the field value with all the defined characters escaped.

# Input: Field to be escaped - Return: Escaped field
#
sub EscapeFieldValue
{

my($efld) = @_;
my($tmp, $i, $tmp2, @sstCvtHx);
for($i = 0;$i < 256;$i++) {

$sstCvtHx[$i] = sprintf(“%%%2.2X”,$i);

}
$efld =˜ s [symbol] % [symbol] %25/sg; # FIRST escape the escape character ‘%’
for($i = 0;$i < 256;$i++) {

if( $i < 48 ∥ ($i > 57 && $i < 65) ∥
($i > 90 && $i < 97) ∥ ($i > 122) ) {

if($i != 37) { # don't do the escape character again.

$tmp = chr($i);
$tmp = “\\” . $tmp;
$tmp2 = $sstCvtHx[$i];
$efld =˜ s/$tmp/$tmp2/sg;

}

}

}
return($efld);

}

As this field escaping function demonstrates, field values to be escaped may be defined for a wide range of characters in order to accommodate the directory naming requirements of many underlying operating systems within a single code base.

It should be noted that the escaping technique used, being a conventional technique, could be replaced in the embodiment in order to meet a variety of design requirements. The escaping technique selected for this embodiment uses a fixed width escape sequence to impart design advantages associated with fixed size escape sequences. However, escape techniques which use less storage space may be specified where storage space requirements are deemed to be a critical design consideration.

Referring still to FIG. 1, each field value from a record is processed based on 2 whether it is to be stored within the directory entry currently being constructed or elsewhere.

Valid directory names are constructed from field values that have been escaped as described along with character values defined by the embodiment for use as field separator characters. Escaped field values are concatenated together 7, with each field separated by field separator characters 8. The resulting directory entry, once completed 2 is stored as a valid directory entry within the underlying operating system 9. Any remaining fields from the record that are not required to be stored in the directory entry 10 are stored in another area, outside of the directory entry just constructed 11. The embodiment represented in the chart also includes an optional step 6 that insures constructed directory entries have no leading field separators.

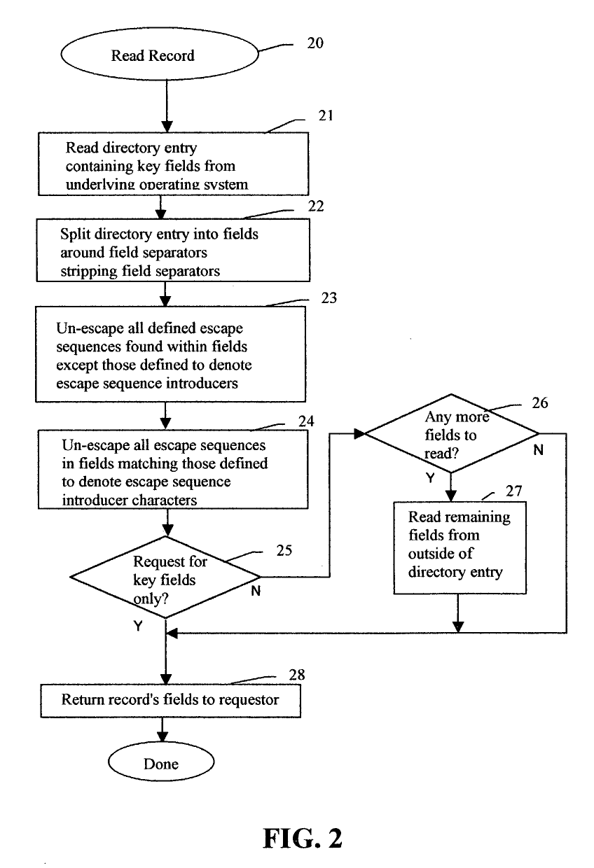

FIG. 2 on sheet two of the drawing shows a view of a flow chart representing the process of reading a record 20 in the embodiment of the invention wherein field separators are used within directory entries. To retrieve field values stored in directory entries, the directory entry is read from the underlying operating system 21, the fields stored within the directory entry are extracted by splitting the directory entry apart at the field separator characters and discarding any field separator characters that may remain 22. The resulting field values are un-escaped to recover the original character values that had been escaped when the field values were stored in directory entries of the underlying operating system 23. Escape sequences that represent character values used to introduce escape sequences are un-escaped last 24 so that they are not mistaken as escape sequence introducers in subsequent transformations. If fields other than those being stored within a directory entry are being requested 25 and there are other fields within the record to retrieve 26, then those are read from another area of storage outside of the directory entry 27. Fields retrieved are returned to the requestor 28, completing the process.

The following software function, written in the perl programming language demonstrates an example of an un-escaping function for use in steps 23 and 24 which takes an escaped field value as input and returns the original un-escaped field value.

# In: A field value to be un-escaped
# Out: the field value un-escaped
#
sub UnEscapeFieldValue
{

my($efld) = @_;
my($tmp, $tmp1, $i, @sstCvtHx);
for($i = 0;$i < 256;$i++) {

$sstCvtHx[$i] = sprintf(“%%%2.2X”,$i);

}
for($i = 0;$i < 256;$i++) {

if($i < 48 ∥ ($i > 57 && $i < 65) ∥
($i > 90 && $i < 97) ∥ ($i > 122) ) {

if($i != 37) { # don't do the escape character yet.

$tmp1 = $sstCvtHx[$i];
$tmp1 =˜ s [symbol] %(.*)/$1/sg;
$tmp = chr(hex($tmp1));
$efld =˜ s [symbol] %$tmp1/$tmp/sg;

}

}

}
$efld =˜ s [symbol] %25 [symbol] %/sg; # LAST un-escape the escape character.
return($efld);

}

As noted, the escaping and un-escaping technique used, being a conventional technique, can be replaced in the embodiment in order to meet a variety of design requirements. However, the un-escaping technique used must mirror the escaping technique used for a given underlying operating system or set of underlying operating systems.

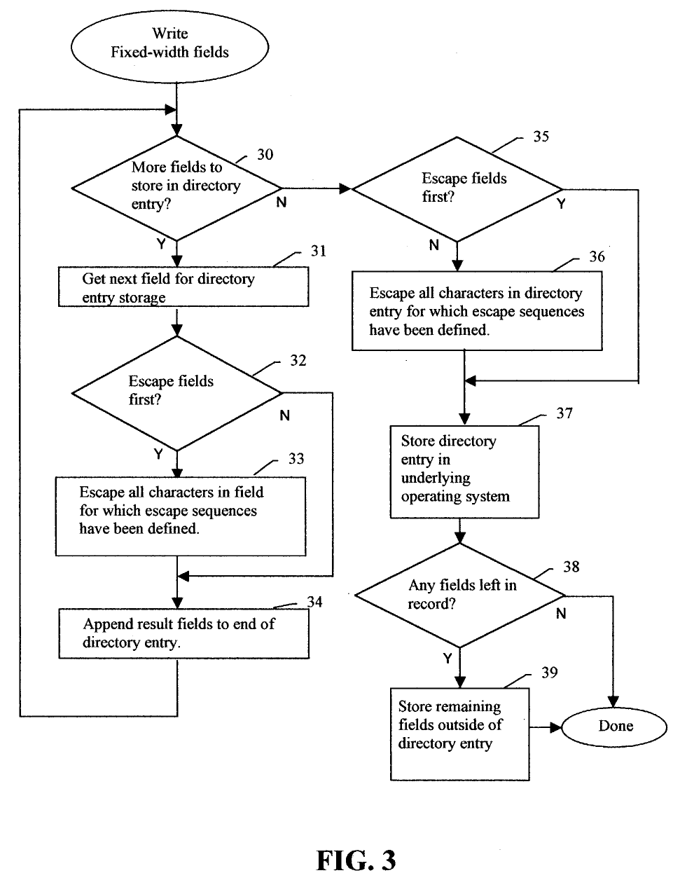

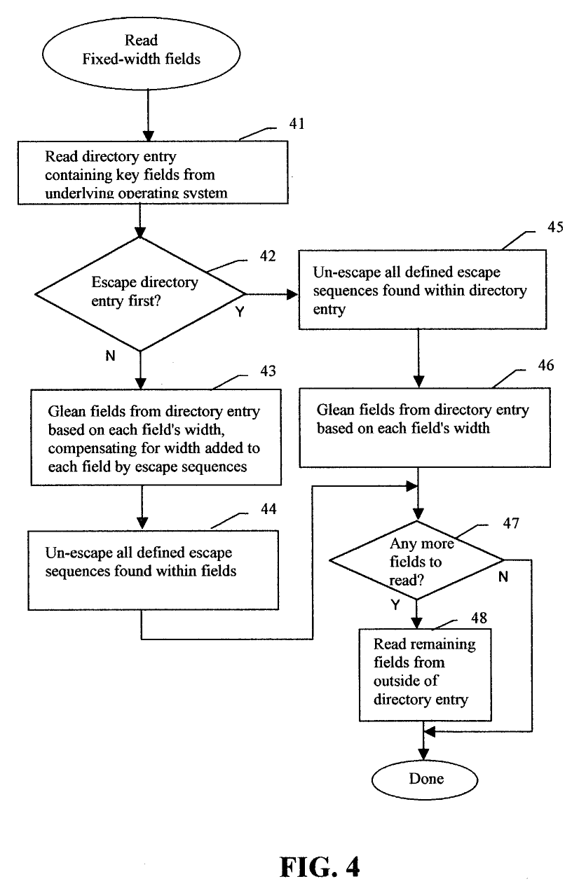

FIG. 3. and FIG. 4. of the drawing sheets show views of flowcharts representing a mode of the invention that may be employed when field values are imparted with a fixed width across records of like type. Such cases demonstrate one circumstance wherein fields may be stored and retrieved without using field separators.

FIG. 3. On sheet three of the drawing is a view of a flowchart that demonstrates a mode of storing fields from records where fields are of fixed width. For each field 31, if the fields are to be escaped before 32 constructing the directory entry 34 they are escaped by conventional means 33 in the fashion previously discussed wherein escape sequence introducers are escaped first. In either case, the field values are appended to the directory entry 34. When all fields for storage within the directory entry have been processed and appended to the directory entry 30, if the constituent fields have already been escaped 35, the directory entry is stored in the underlying operating system 37, if the fields were not escaped individually 33, the entire directory entry is escaped as a single entity 36 and then stored 37. If there are any fields remaining in the record 38, those fields are stored in another area of storage outside the directory entry just stored 39.

FIG. 4 on sheet four of the drawing shows a view of a flow chart representing the process of reading a record wherein separators are not used to delimit field values within directory entries, such as when fields are of fixed width. Each directory entry having field values to be recovered is read from the underlying operating system 41. If the entire directory is to be un-escaped as a single entity 42 it is un-escaped in a conventional fashion as has been described 45 and fields are gleaned from it by breaking it into fields based on the known fixed width of each field 46. If the fields are to be gleaned before being escaped 42, the fields are gleaned in similar fashion but compensating for any added width in each field that may be caused by the presence of escape sequences 43. Said fields that have been gleaned before being un-escaped must be un-escaped individually 44. In either case, if there are more fields to be read 47 that were not stored in the current directory entry, those fields are read from a location outside of the directory entry just processed 48, completing the process.

While the present invention has been described in detail and pictorially in the accompanying drawings it is not limited to such details since many changes and modifications recognizable to those of ordinary skill in the art may be made to the invention without departing from the spirit and the scope thereof.

I claim:

1. A method of storing and retrieving records of a database by storing some or all field values from said records within directory entries of an underlying operating system, wherein more than one field value is stored for a specific record within each single directory entry in the underlying operating system; said method comprising;
(a) escape sequences composed of sequences of characters that are acceptable for use within directory entries in said underlying operating system and including at least one such character to serve as the escape sequence introducer;
(b) a set of said escape sequences consisting of at least one escape sequence to represent each character that is unacceptable within directory entries within the underlying operating system, one escape sequence to represent characters used by the method to separate field values within directory entries, and one escape sequence to represent each of the characters used as escape sequence introducers, and;
(c) storing said field values of said records by processing means comprised of:
(c1) escaping field values to be stored within said directory entries by replacing characters within field values matching the characters for which escape sequences have been defined in said set of escape sequences, such that characters used by the method as escape sequence introducers are escaped before all other characters for which escape sequences have been define in said set of escape sequences;
(c2) producing a string of characters which is composed of said escaped field values, separated by said field separators concatenated together into a single string, and;
(c3) storing said string of characters as said directory entry within said underlying operating system;
(d) a means of recovering said field values of said records by reading directory entries containing said field values from said underlying operating system and converting them into field values by processing means comprised of:
(d1) splitting said directory entry at field separator characters into separate fields;
(d2) un-escaping said field values by replacing all escape sequences found within each field value that match escape sequences from said set of escape sequences with the characters each escape sequence has been defined to represent, and such that the escape sequences that have been defined to represent said escape sequence introducer characters are replaced last; thereby recovering field values exactly matching the field values that were stored within said directory entry.

2. A method of storing and retrieving records of a database by storing some or all field values from said records within directory entries of an underlying operating system, wherein more than one field value is stored for a specific record within in each single directory entry in the underlying operating system, and wherein each field value of the record to be stored within directory entries of the underlying operating system is imparted a field width which is fixed from record to record; said method comprising:
(a) escape sequences composed of sequences of characters that are acceptable for use within directory entries in said underlying operating system and including at least one such character to serve as the escape sequence introducer;
(b) a set of said escape sequences consisting of at least one escape sequence to represent each character that is unacceptable within directory entries within the underlying operating system, and one escape sequence to represent each of the characters used as escape sequence introducers;
(c) storing said field values of said records by processing means comprised of
(c1) escaping field values to be stored within said directory entries by replacing characters within field values matching the characters for which escape sequences have been defined in said set of escape sequences, such that characters used by the method as escape sequence introducers are escaped before all other characters for which escape sequences have been define in said set of escape sequences;
(c2) producing a string of characters which is composed of said field values either before or after being escaped, concatenated together into a single string, and;
(c3) storing said string of characters as said directory entry within said underlying operating system;
(d) a means of recovering said field values of said records by reading directory entries containing said field values from said underlying operating system and converting each directory entry into field values by processing means comprised of:
(d1) un-escaping said field values by replacing all escape sequences found within each field value within said directory entry that match escape sequences from said set of escape sequences with the characters each escape sequence has been defined to represent, and such that the escape sequences that have been defined to represent escape sequence introducer characters are replaced last;
(d2) gleaning each field value from said directory entry by extracting a sub-string which is of length equal to said fixed length imparted to the field value, and starting from a character position within the directory entry which is one greater than the total number of characters in the combined fields preceding the field being gleaned, and allowing for the added size of escaped characters when such gleaning of said field values is performed prior to un-escaping them; thereby recovering field values exactly matching the field values that were stored within said directory entry.

3. A method for storing and retrieving field values of database records as per claim 1, wherein said field separator is comprised of a character value or sequence that has special meaning to the underlying operating system as a means of separating fields within directory entries, such as the period character in UNIX and Windows operating systems.

4. A method for storing and retrieving field values of database records as per claim 1, wherein said field separator is comprised of a character value or sequence that has special meaning to the underlying operating system as a means of representing hierarchical directory levels within directory entries, such as the forward slash (‘/’) in UNIX and the back slash (‘\’) in Windows systems.

5. A method for storing and retrieving field values of database records as per claim 1, wherein said field separators are comprised of a combination of character values or sequences that have special meaning to said underlying operating system, as a means of representing hierarchical directory levels within directory entries, or as a means of separating fields within directory entries.

6. A method of storing and retrieving field values of database records as per claim 1, wherein key field values from each specific record are stored within a directory entry that names a file, and the remainder of the field values from said specific record are stored as content within said file so named.

7. A method of storing and retrieving field values of database records as per claim 1, wherein key field values from each specific record are stored within a directory entry that names a directory in the underlying operating system, and some or all remaining field values from said specific record are stored as directory entries within said directory so named.

8. A method of storing and retrieving field values of database records as per claim 2, wherein key field values from each specific record are stored within a directory entry that names a file, and the remainder of the field values from said specific record are stored as content within said file so named.

9. A method of storing and retrieving field values of database records as per claim 2, wherein key field values from each specific record are stored within a directory entry that names a directory in the underlying operating system, and some or all remaining field values from said specific record are stored as directory entries within said directory so named.
